(19) United States
(12) Patent Application Publication
(10) Pub. No.: US 2012/0034806 A1
(43) Pub. Date: Feb. 9, 2012

(54) METHOD AND SYSTEM FOR ATTACHING THE ELECTRICAL WIRES OF FIXTURE OR APPLIANCE THAT HANGS FROM A CEILING OR WALL

(76) Inventor: Nathan Dean Ehrlich, Duluth, GA (US)

(21) Appl. No.: 12/849,708

(22) Filed: Aug. 3, 2010

(51) Int. Cl. H01R 13/627

(52) U.S. Cl. 439/356

(57) ABSTRACT

An apparatus for easily connecting the wires of a fixture or appliance to the wires carrying the electrical current of a building or structure comprised of a first piece that secures to an outlet box in a ceiling or wall and a second piece that fits over the first piece. The wires carrying the electrical current are affixed to electrical conductors of the first piece. When the second piece, already a part of the fixture or appliance to be installed, is fitted over the first piece, the electric connections are completed and the electrical current travels to the fixture or appliance.

### FIELD OF INVENTION

The invention generally relates to an electrical light fixture or fan. More specifically, the invention relates to connecting the wires of the fixture or fan to the wires carrying the electrical current.

### BACKGROUND OF INVENTION

Most light fixtures are generally installed in much the same fashion: wires from the fixture are attached to wires extending from an electrical box that carry the electric current. The fixture is then secured to the outlet box by means of a single or plurality of screws running through the fixture and into the outlet box.

In order to attach these wires from the outlet box to the fixture the installer is required to hold the fixture in one hand while attaching the wires with the other hand. There are commonly, but not limited to, three wires that extend from the outlet box that must be attached securely to the wires of the fixture. Most commonly the three wires are identified as a positive wire, a negative wire and a ground wire. Each of these wires is affixed to one or more wires of the fixture.

The wires are attached by first stripping approximately ½ inch of protective coating from the end of each wire, thus exposing the metallic material inside the wire that carries the current. The wires to be connected are then held together, side by side, with the exposed part of the wires adjacent to one another. The exposed wired are then twisted together in a clockwise direction.

To protect the exposed wires and keep them securely attached to one another, a “wire nut” is then screwed over the exposed twisted wires. The wire nut is a cone shaped devise with threads inside the cone to grab onto the exposed wires when screwed on.

Often, to further secure the connected wires and hold the wire nut in place, the installer will wrap the bottom of the wire nut with electrical tape, extending the wrapping down over the first half inch to one inch of coated wire leading into the wire nut.

After all the connections are completed, the wires and wire nuts are pushed into the outlet box, the fixture is positioned in place and secured to the outlet box according to the specific design of the fixture. Frequently, but not exclusively, the fixture is secured with one or more screws passing through a hole or holes in the fixture and into a predetermined threaded hole or holes in the outlet box.

Accordingly, there is a need to simplify this process such that the installer does not need to hold the fixture in one hand, or permit the fixture to hang from the attached wires, while concurrently completing the electrical connections.

### SUMMARY

A fixture can be connected to the electrical current and secured in place without the need to twist wires together; without the need to secure and protect the connected wires with wire nuts, and without the need to hold the fixture or allow it to hang from the attached wires while concurrently completing the electrical connections.

The connection of the electrical current can be made to the fixture by first attaching a preformed ring to the outlet box that already exists in the ceiling or wall. This ring is the same diameter (usually 3½ inches) as the outlet box that is used in nearly every application. The ring is continuous and is open on the top and bottom. The ring has two extensions on its inside surface on opposite sides, with a hole that aligns with prefabricated holes in the outlet box. A screw slides though each of the holes in each inside extension and screws into the preformed threaded holes in the outlet box, thus fastening the ring securely to the outlet box.

The ring has receptacles extending from its inside perimeter. Each receptacle has a hole for one wire. The installer inserts the exposed part of the wire extending from the outlet box into a hole in a receptacle. The receptacles may be color coded or marked with some identifying symbol to instruct the installer which wire to insert into each of the receptacles.

Once inside the receptacle the exposed wire makes contact with a metal surface that will conduct electrical current. This metal inside the receptacle extends through the ring to a contact point (ring contact) on the outside of the ring.

After each of the wires extending from the outlet box is positioned in a receptacle the installer is ready to attach the fixture.

The piece of the fixture (fixture housing) that aligns with the installed ring is of a round shape and of a corresponding size to slide over the installed ring. This fixture housing has separate and individual contact points on its inside surface. Each of these contact points aligns with and touches one, and only one, of the metal extensions on the outside of the installed ring.

Each of the housing fixture contact points carries the electrical current directly to the fixture.

Once in position, the fixture may be secured by a variety of methods: including but not limited to screws or hooks extending from the outside of the installed ring may slide into holes and/or notches prepositioned on the outside ring; holes in the outside ring may be prepositioned to allow securing to the outlet box or installed ring with screws or bolts; a threaded nipple may extend through the center of the outside ring which may permit securing the fixture with a locknut.

### BRIEF DESCRIPTION OF DRAWINGS

FIG. 1 illustrates the open ring.

FIG. 2 illustrates the outlet box, already installed in a ceiling or wall; the front surface being flush or slightly recessed with the surface of the wall or ceiling.

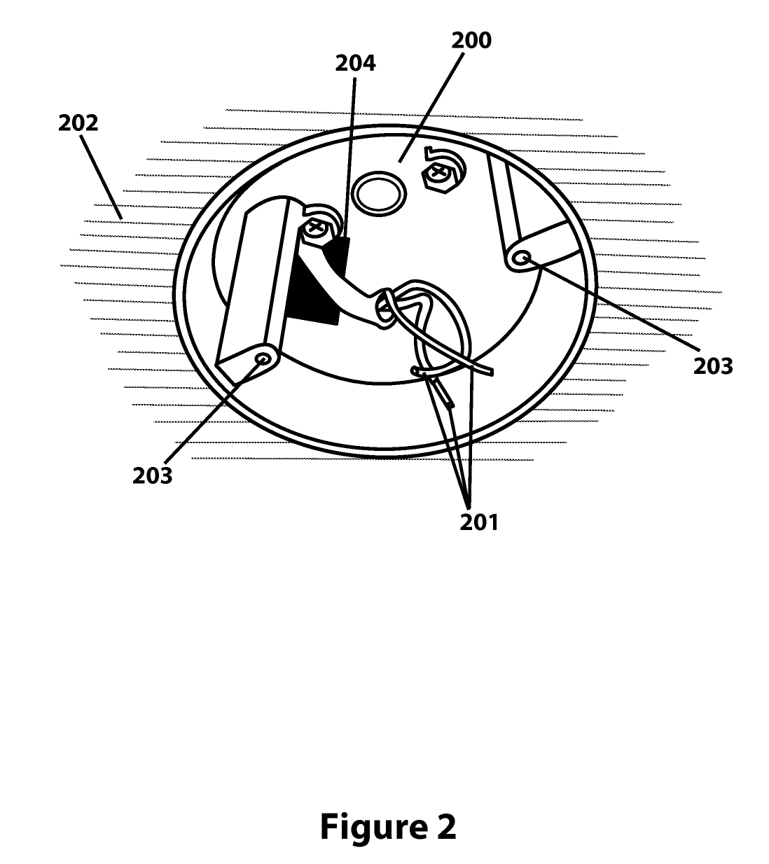

FIG. 3 illustrates the ring affixed to the outlet box.

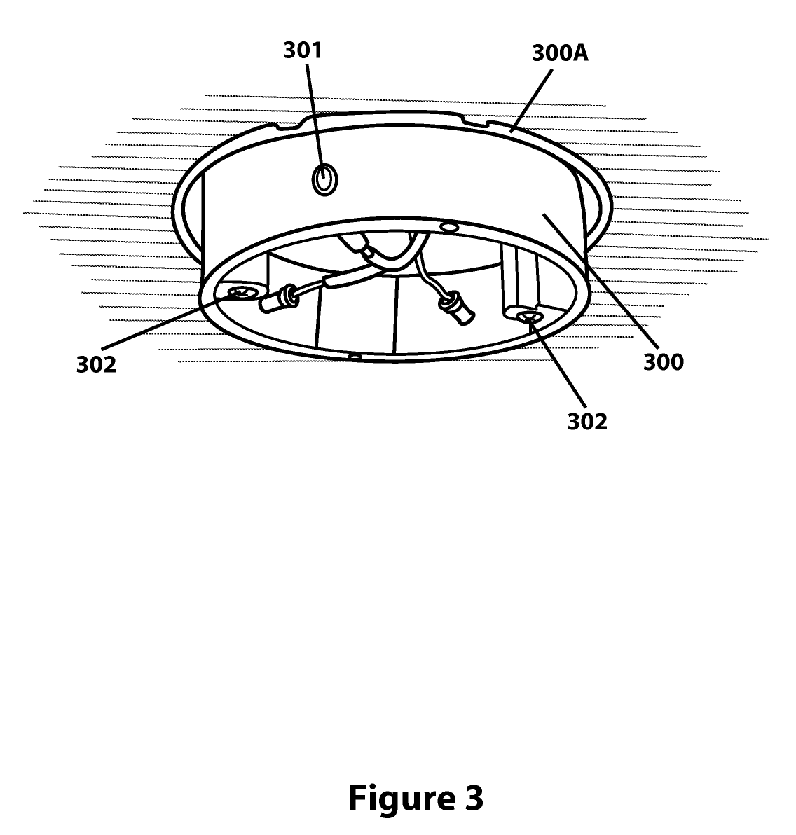

FIG. 4 illustrates the wires from the outlet box inserted into the receptacles of the ring.

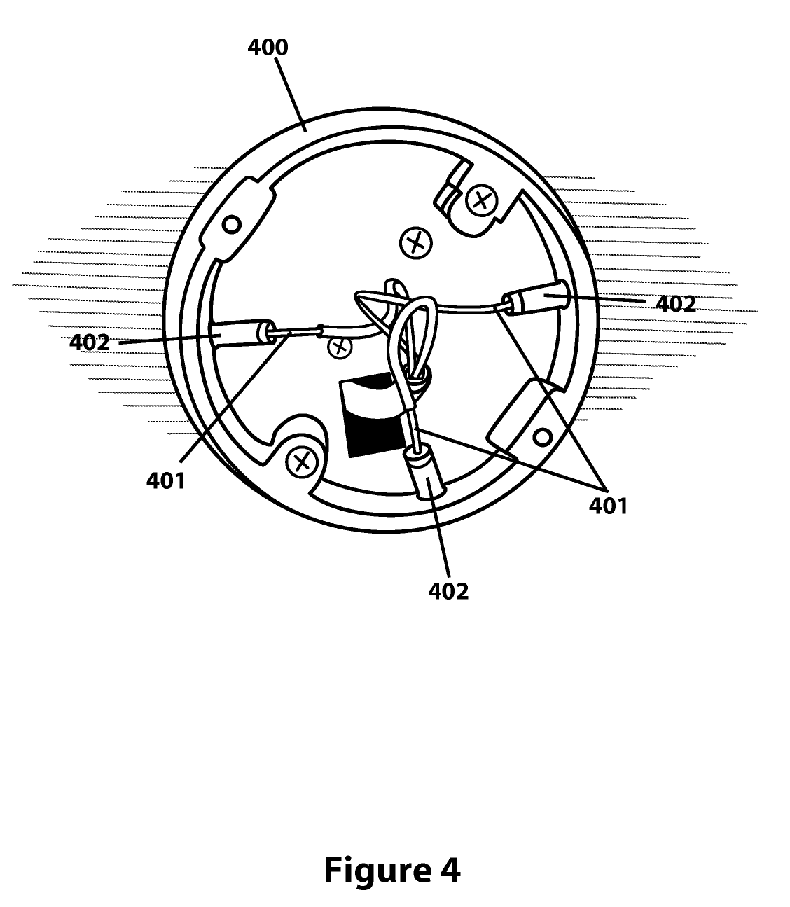

FIG. 5 Illustrates one of the contact points on the outside of the installed ring.

FIG. 6 illustrates a simple lighting fixture and the contact points inside the fixture housing.

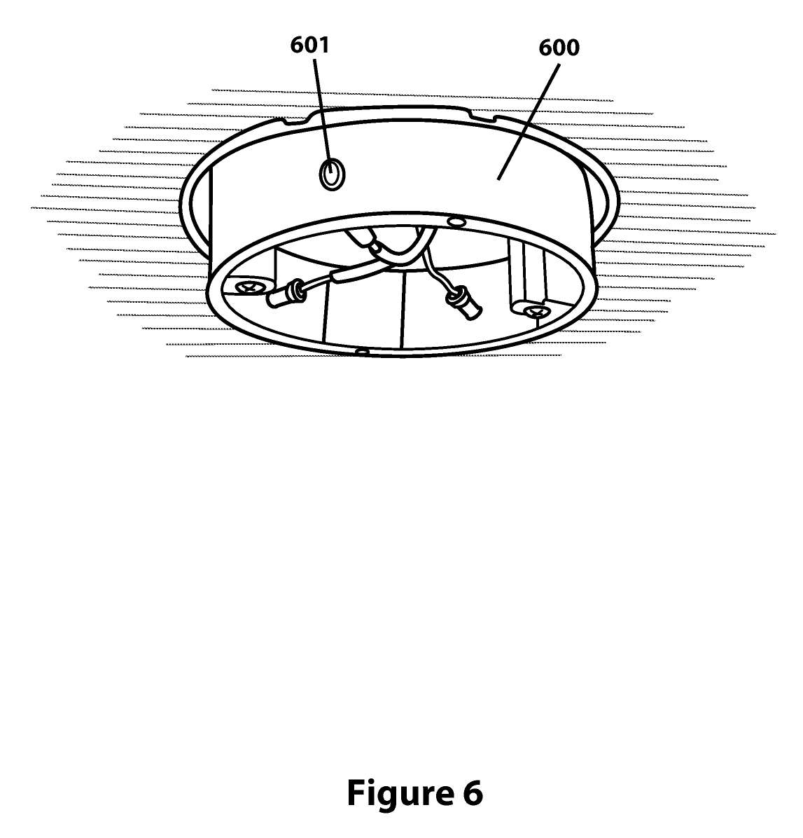

### DETAILED DESCRIPTION

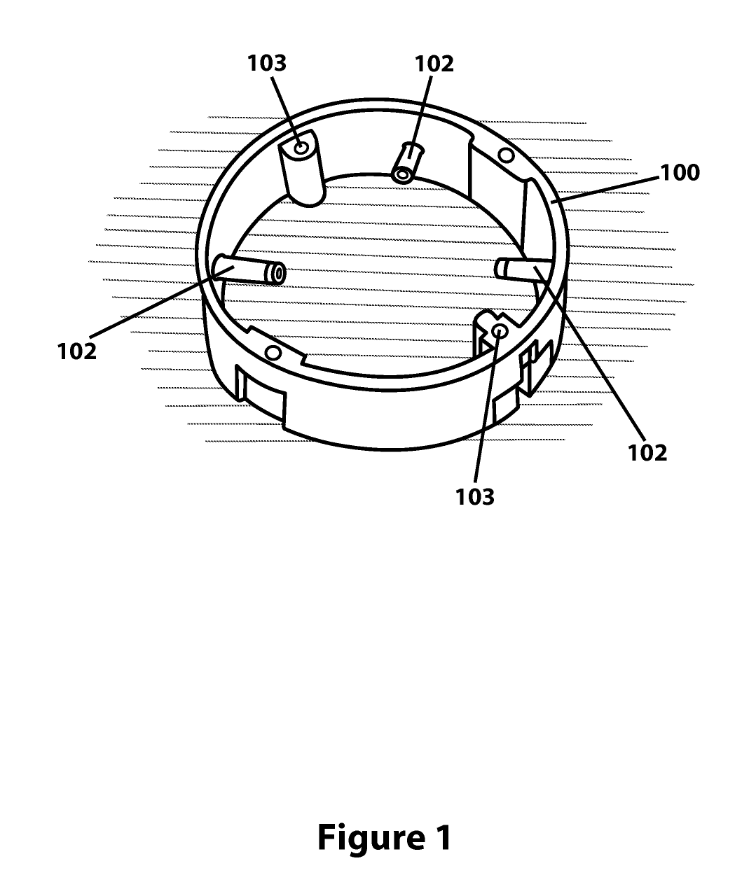

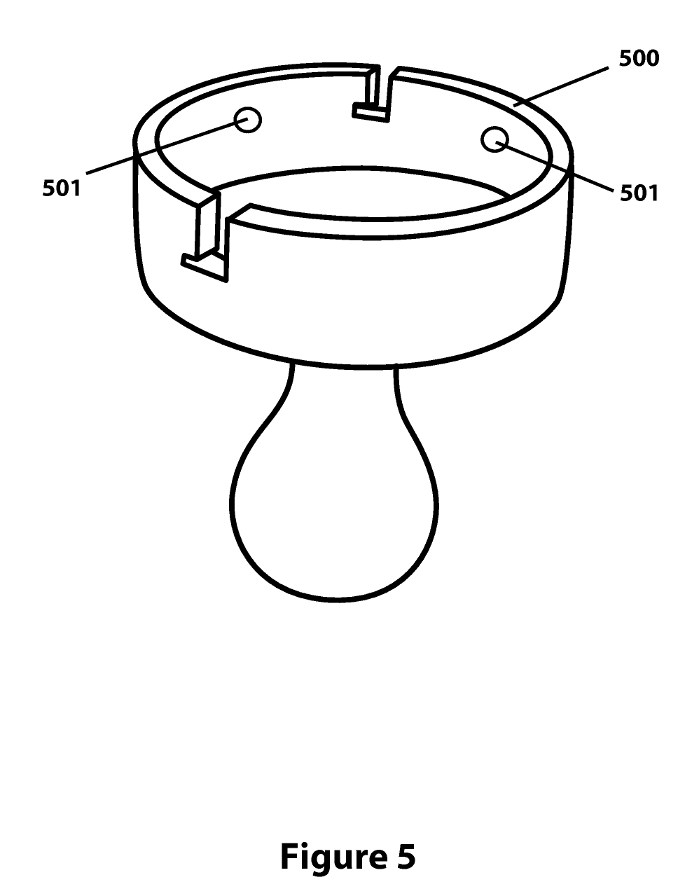

Referring now to the drawings wherein the showings are for purposes of illustrating preferred embodiments of the present invention only, and not for the purposes of limiting the same, FIG. 1 and FIG. 5 illustrate the embodiment of the devise for making electrical connections to an electrical fixture; the fixture for illustrative purposes only as shown in FIG. 5.

As will be described in greater detail below, a plurality of wires 201 can be quickly and easily inserted into receptacles 102 of the ring 100. Each receptacle carries the electrical current to a point outside the ring 301 where it may be transferred by contact to a point 501 on the fixture housing 500 which in turn will carry the electrical current to the fixture.

Nearly all construction has an electrical outlet box 200 installed in the ceiling or wall 202 positioned in a place for the ceiling fixture or wall fixture to be installed. The electrical outlet box 200 nearly always follows one of two standard sizes, both of which have prepositioned threaded holes 203 on opposite sides of the inside perimeter of the outlet box spaced 2¾″ from the corresponding prepositioned threaded hole on the opposite side of the inside perimeter of the outlet box 200. The electrical wires 201 carrying the electrical current extend through an open hole 204 in the top of the electrical box.

The fixture installation begins with the assembly of the ring 100 to the outlet box 200. Screws 302 are inserted through the prepositioned holes 103 on opposite sides of the ring 100. The screws are then inserted into the corresponding prepositioned and threaded holes 203 of the outlet box 200 and tightened so that the ring 300 sits flush with the outlet box 300A.

The exposed wires 401 extending through the open hole 204 in the outlet box 200 are then inserted into the receptacles 402 of the ring 400. When inserted, the exposed wires 401 make contact with a metal surface inside the receptacle 402. This electricity conducting metal extends through the perimeter of the ring 300 to a contact point 301 on the perimeter surface of the ring 300.

The receptacle for the exposed wire may be one of a variety of designs including but not limited to a screw that the exposed wire is wrapped around and then tightened, a clip that firmly holds the exposed wire, or an open sleeve that the exposed wire slides into and is gripped inside the sleeve by a spring.

Each of the contact points 301 on the perimeter of the ring 300 is at this stage carrying the electric current.

The fixture to be installed has a housing 500 similar in shape as the ring 600; only slightly larger so that the housing 500 will slide over the ring 600. Inside of the housing 500 are an equal number of contact points 501 as there are contact points 601 on the outside perimeter of the ring 600.

When the housing 500 slides over the ring 300, the contact points 501 on the housing 500 come into convergence with the corresponding contact points 301 on the ring 300.

It is from this point in the housing 500 that the electric current is carried to the fixture by way of wires that run from the contact point in the housing to the fixture.

The final securing of the housing 500 to the ring 300 may take place in a variety of methods, none of which are a part of this application. These methods may be, but are not limited to: inserting and tightening a plurality of screws through prepositioned holes in the housing 500 and ring 300; or securing a threaded nipple through a hole in the center of the housing and into an outlet box strap preinstalled for that purpose into the outlet box 200 before installing the ring 300.

What is claimed is:

1. An apparatus for easy connection of an electrical fixture or appliance to the electrical wires of a building or structure running through an electrical box installed in a ceiling or wall, consisting of:
a) a first ring or cylinder, said ring or cylinder having an inside and an outside surface, open at both the top and the bottom;
b) a second ring or cylinder, said ring or cylinder being of a size to slide outside first ring or cylinder with second ring or cylinder being a part of the electrical fixture or appliance being installed.

2. The apparatus of claim 1 wherein the first ring or cylinder is provided with holes positioned such that screws may slide through said holes and into the threaded holes of an electrical box;

3. The apparatus of claim 1 wherein the first ring or cylinder consists of a plurality of female electrical connectors on the inside of the ring or cylinder;

4. The apparatus of claim 3 wherein the electrical connectors extend through the inside and outside surface of the ring or cylinder;

5. The apparatus of claim 4 wherein the electrical connectors are accessible on the outside surface of the ring or cylinder;

6. The apparatus of claim 1 wherein the second ring or cylinder consists of electrical contact points on the inside surface of the ring or cylinder;

7. The apparatus of claim 6 wherein the electrical contact points align with the electrical connectors accessible on the outside surface of the first ring or cylinder of claim 5;

8. The apparatus of claim 7 wherein the electrical contact points are connected to the wires of the fixture or appliance to be stalled;

9. The apparatus of claim 1 wherein the electrical fixture or appliance is a fan;

10. The apparatus of claim 1 wherein the first ring or cylinder and the second ring or cylinder may be of any shape with or without a plurality of sides in so far as the two pieces fit together.

11. The apparatus of claim 2 wherein the first ring or cylinder and the electrical box are a single continuous piece.
